(19) United States
(12) Patent Application Publication
(10) Pub. No.: US 2009/0119277 A1
(43) Pub. Date: May 7, 2009

(54) DIFFERENTIATION OF FIELD ATTRIBUTES AS VALUE CONSTRAINING VERSUS RECORD SET CONSTRAINING

(76) Inventors: Richard Dean Dettinger, Rochester, MN (US); Frederick Allyn Kulack, Rochester, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(21) Appl. No.: 11/936,257

(22) Filed: Nov. 7, 2007

(51) Int. Cl. G06F 17/30

(52) U.S. Cl. 707/5; 707/E17.014

(57) ABSTRACT

Embodiments of the invention provide a method for creating value constraints and record constraints for entity based conditions, while (at least in some cases) reducing the amount of time and errors associated with manually composing query language statements (e.g., SQL). When composing an abstract query, a query interface may be provided for a user to input value constraints and record set constrains to create entity based conditions. The entity based conditions may specify a condition which is evaluated against all rows of data for an instance of a given model entity, and a record set constraint allows a user to specify a subset of records against which the entity based condition is applied.

### BACKGROUND OF THE INVENTION

1. Field of the Invention

Embodiments of the invention generally relate to computer database systems. More particularly, the invention relates to techniques for applying value constraints and record set constraints to entity based conditions, and for building a query from those conditions.

2. Description of the Related Art

Databases are well known systems for storing, searching, and retrieving information stored in a computer. The most prevalent type of database used today is the relational database, which stores data using a set of tables that may be reorganized and accessed in a number of different ways. Users access information in relational databases using a relational database management system (DBMS).

Each table in a relational database includes a set of one or more columns. Each column typically specifies a name and a data type (e.g., integer, float, string, etc), and may be used to store a common element of data. For example, in a table storing data about patients treated at a hospital, each patient might be referenced using a patient identification number stored in a “patient ID” column. Reading across the rows of such a table would provide data about a particular patient. Tables that share at least one attribute in common are said to be “related.” Further, tables without a common attribute may be related through other tables that do share common attributes. A path between two tables is often referred to as a “join,” and columns from tables related through a join may be combined to from a new table returned as a set of query results.

Queries of a relational database may specify which columns to retrieve data from, how to join the columns together, and conditions (predicates) that must be satisfied for a particular data item to be included in a query result table. Current relational databases require that queries be composed in complex query languages. Today, the most widely used query language is Structured Query Language (SQL). However, other query languages are also used. An SQL query is composed from one or more clauses set off by a keyword. Well-known SQL keywords include the SELECT, WHERE, FROM, HAVING, ORDER BY, and GROUP BY keywords. Composing a proper SQL query requires that a user understand both the structure and content of the relational database as well as the complex syntax of the SQL query language (or other query language).

### SUMMARY OF THE INVENTION

Embodiments of the invention generally provide techniques for applying value constraints and record set constraints to entity based conditions, while reducing the amount of time and errors associated with manually composing query code.

One embodiment of the invention includes a method of processing an abstract query composed from a plurality of logical fields specified by a data abstraction model constructed for an underlying physical database. The method generally includes receiving an abstract query composed from one or more of the plurality of logical fields. The abstract query includes a selection of a model entity, and the model entity specifies a logical focus for the abstract query. The abstract query may further include (i) an entity based condition specifying a condition which must be satisfied for each value included in a collection of values related to a given instance of the model entity in order for the given instance of the model entity to be included in query output; and (ii) a record set constraint specifying a condition to constrain the collection of records against which the entity based condition is evaluated. The method may generally include generating a resolved query of the underlying physical database; executing the resolved query to retrieve a set of query output that includes a set of instances of the model entity that satisfy the entity based condition; and returning the query output to a user.

Another embodiment of the invention includes a computer-readable storage medium containing a program which, when executed, performs an operation for processing an abstract query composed from a plurality of logical fields specified by a data abstraction model constructed for an underlying physical database. The operation may generally include receiving an abstract query composed from one or more of the plurality of logical fields. The abstract query includes a selection of a model entity, and the model entity specifies a logical focus for the abstract query. The abstract query may further include (i) an entity based condition specifying a condition which must be satisfied for each value included in a collection of values related to a given instance of the model entity in order for the given instance of the model entity to be included in query output, and (ii) a record set constraint specifying a condition to constrain the collection of records against which the entity based condition is evaluated. The operation may further include generating a resolved query of the underlying physical database, executing the resolved query to retrieve a set of query output that includes a set of instances of the model entity that satisfy the entity based condition, and returning the query output to a user.

Yet another embodiment of the invention includes a system having a processor and a memory containing a program configured to perform an operation for processing an abstract query composed from a plurality of logical fields specified by a data abstraction model constructed for an underlying physical database The operation may generally include receiving an abstract query composed from one or more of the plurality of logical fields. The abstract query includes a selection of a model entity, and the model entity specifies a logical focus for the abstract query. The abstract query may further include (i) an entity based condition specifying a condition which must be satisfied for each value included in a collection of values related to a given instance of the model entity in order for the given instance of the model entity to be included in query output, and (ii) a record set constraint specifying a condition to constrain the collection of records against which the entity based condition is evaluated. The operation may further include generating a resolved query of the underlying physical database, executing the resolved query to retrieve a set of query output that includes a set of instances of the model entity that satisfy the entity based condition, and returning the query output to a user.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 illustrates a network environment using a client-server configuration, according to one embodiment of the invention.

FIGS. 2A and 2B illustrate a logical view of a database abstraction model constructed over an underlying physical database, according to one embodiment of the invention.

FIG. 3 illustrates an example of using a logical field to create a record set constraint for an entity based condition, according to one embodiment of the invention.

FIG. 4 illustrates another example of using a logical field to create a record set constraint for an entity based condition, according to one embodiment of the invention.

FIG. 5 illustrates another example of using a logical field to specify a record set constraint for an entity based condition, according to one embodiment of the invention.

FIG. 6 illustrates an example query interface used to compose an abstract query that includes both value and record set constraints, according to one embodiment of the invention.

FIG. 7 illustrates an example interface used to add value constraints and record set constraints to an abstract query, according to one embodiment of the invention.

FIG. 8 illustrates an example query interface used to build an entity based condition that includes a record set constraint, according to one embodiment of the invention.

FIG. 9 is a flow diagram illustrating a method for generating value and record set constraints for creating entity based conditions for an abstract query, according to one embodiment of the invention.

FIG. 10 is a flow diagram illustrating a method for building a resolved query for an abstract query that includes an entity based condition with value and record set constraints, according to one embodiment of the invention.

### DETAILED DESCRIPTION OF THE PREFERRED EMBODIMENTS

The complexity of constructing an SQL statement makes it difficult for average users to compose queries of a relational database, particularly when applying record set constraints to entity based conditions. An entity based condition is a value constraint (for example, “hemoglobin_test>15”) which is evaluated against all rows of data for an instance of a given entity (for example, a patient). The rows of data are used to include (or exclude) instances of the entity depending on whether they satisfy the value constraint. For example, if the entity based condition is “hemoglobin_test>15,” and if a particular patient meets that condition for every measurement, then data regarding all hemoglobin tests may included in query output. Otherwise, data regarding that patient is not included in query output, even if only one row of data violates the condition (for example, if only one hemoglobin measurement was less than 15). Thus, the entity based condition is applied to the entity as a whole.

Applying record set constraints to the entity based condition makes a query difficult to construct. A record set constraint allows a user to specify a subset of records to which the entity based condition is applied. For example, a researcher may want to look at all of the records for patients who always had high hemoglobin (“hemoglobin_test>15”) while they were children. The record set constraint would be “AgeAtTest<18.” If a particular patient always had high hemoglobin as a child, then all of the patient's records would be returned in the output (including data taken when the patient was an adult). Even if the patient had low hemoglobin when he was 20 years old, he would be selected, because the entity based condition (“hemoglobin_test>15”) is satisfied for the record subset (AgeAtTest<18).

One embodiment of the invention provides a method that allows a user to compose value constraints and/or record set constraints for an entity based condition, and that builds a query from those conditions. To create value constraints and record set constraints for an entity based condition, the user first selects a logical field to include in a query condition. Next, the user specifies the value constraining condition. Then, the user designates the condition as an entity based condition. For example, the user may specify that either all records related to a given entity must meet the condition, or no records must meet the condition. Finally, the user specifies one or more record set constraints for the entity based condition. A query is then generated that applies the entity based condition to the subset of data specified by the record set constraints, for each instance of the entity.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

One embodiment of the invention is implemented as a program product for use with a computer system. The program(s) of the program product defines functions of the embodiments (including the methods described herein) and can be contained on a variety of computer-readable media. Illustrative computer-readable media include, but are not limited to: (i) non-writable storage media (e.g., read-only memory devices within a computer such as CD-ROM disks readable by a CD-ROM drive) on which information is permanently stored; (ii) writable storage media (e.g., floppy disks within a diskette drive or hard-disk drive) on which alterable information is stored. Other media include communications media through which information is conveyed to a computer, such as through a computer or telephone network, including wireless communications networks. The latter embodiment specifically includes transmitting information to/from the Internet and other networks. Such computer-readable media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

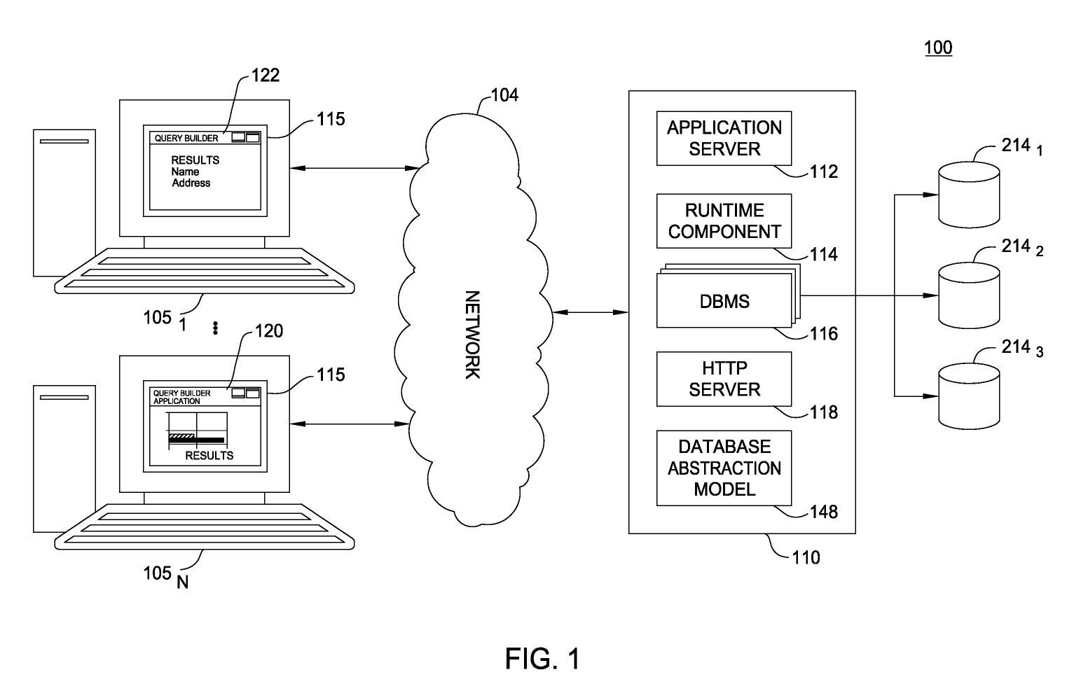

FIG. 1 illustrates a network environment 100 using a client-server configuration, according to one embodiment of the invention. Client computer systems 105_{1-N} include an interface that enables network communications with other systems over network 104. The network 104 may be a local area network where both the client system 105 and server system 110 reside in the same general location, or may be network connections between geographically distributed systems, including network connections over the internet. Client system 105 generally includes a central processing unit (CPU) connected by a bus to memory and storage (not shown). Each client system 105 is typically running an operating system configured to manage interaction between the computer hardware and the higher-level software applications running on the client system 105 (e.g., a Linux® distribution, a version of the Microsoft Windows® operating system IBM's AIX® or OS/400®, FreeBSD, and the like). (“Linux” is a registered trademark of Linus Torvalds in the United States and other countries.)

The server system 110 may include hardware components similar to those used by the client system 105. Accordingly, the server system 110 generally includes a CPU, a memory, and a storage device, coupled by a bus (not shown). The server system 110 is also running an operating system, (e.g., a Linux® distribution, Microsoft Windows®, IBM's OS/400® or AIX®, FreeBSD, and the like).

The network environment 100 illustrated in FIG. 1, however, is merely an example of one computing environment. Embodiments of the present invention may be implemented using other environments, regardless of whether the computer systems are complex multi-user computing systems, such as a cluster of individual computers connected by a high-speed network, single-user workstations, or network appliances lacking non-volatile storage. Further, the software applications illustrated in FIG. 1 and described herein may be implemented using computer software applications executing on existing computer systems, e.g., desktop computers, server computers, laptop computers, tablet computers, and the like. However, the software applications described herein are not limited to any currently existing computing environment or programming language, and may be adapted to take advantage of new computing systems as they become available.

In one embodiment, users interact with the server system 110 using a graphical user interface (GUI) provided by a user interface 115. In a particular embodiment, GUI content may comprise HTML documents (i.e., web-pages) rendered on a client computer system 105₁ using web-browser 122. In such an embodiment, the server system 110 includes a Hypertext Transfer Protocol (HTTP) server 118 (e.g., a web server such as the open source Apache web-server program or IBM's Web Sphere® program) configured to respond to HTTP requests from the client system 105 and to transmit HTML documents to client system 105. The web-pages themselves may be static documents stored on server system 110 or generated dynamically using application server 112 interacting with web-server 118 to service HTTP requests. Alternatively, client application 120 may comprise a database front-end, or query application program running on client system 105_{N}. The web-browser 122 and application 120 may be configured to allow a user to compose an abstract query, and to submit the query to the runtime component 114 for processing.

As illustrated in FIG. 1, server system 110 may further include runtime component 114, database management system (DBMS) 116, and database abstraction model 148. In one embodiment, these components may be provided using software applications executing on the server system 110. The DBMS 116 includes a software application configured to manage databases 214₁₋₃. That is, the DBMS 116 communicates with the underlying physical database system, and manages the physical database environment behind the database abstraction model 148. Users interact with the user interface 115 to compose and submit an abstract query to the runtime component 114 for processing.

In one embodiment, the runtime component 114 may be configured to receive an abstract query, and in response, to generate a “resolved” or “concrete” query that corresponds to the schema of underlying physical databases 214. For example, the runtime component 114 may be configured to generate one or more Structured Query Language (SQL) statements from an abstract query. The resolved queries generated by the runtime component 114 are supplied to DBMS 116 for execution. Additionally, the runtime component 114 may be configured to modify the resolved query with additional restrictions or conditions, based on the focus of the abstract query, i.e., based on the model entity specified for a given query.

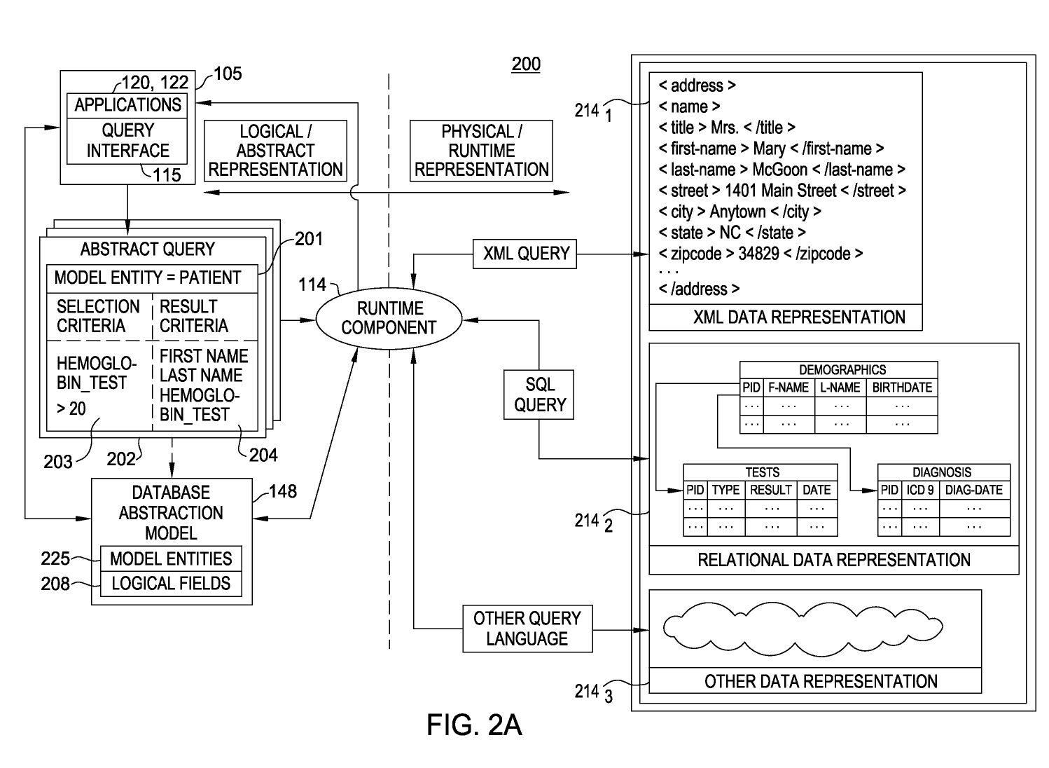

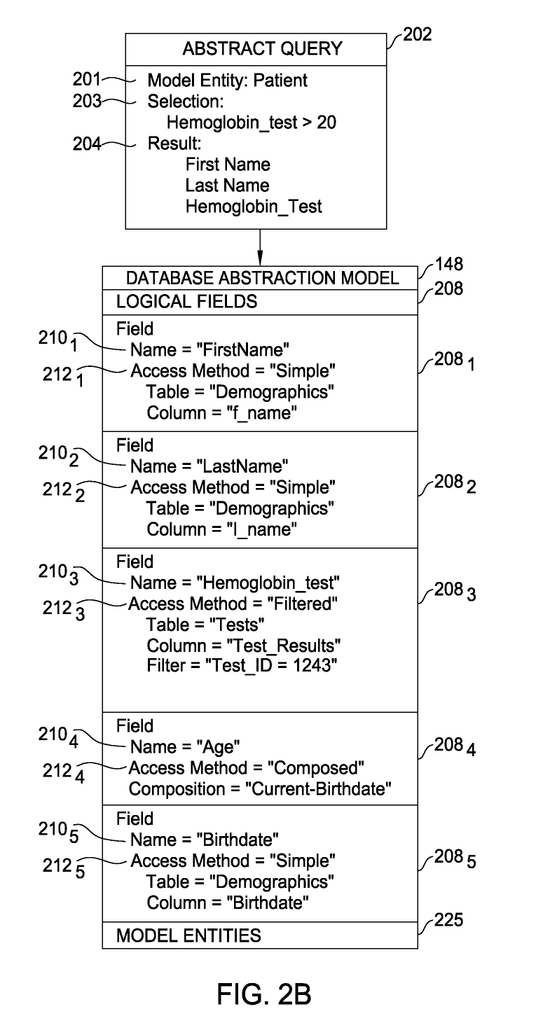

FIG. 2A illustrates a plurality of interrelated components of the invention, along with relationships between the logical view of data provided by the database abstraction model environment (the left side of FIG. 2A), and the underlying physical database environment used to store the data (the right side of FIG. 2A).

In one embodiment, the database abstraction model 148 provides definitions for a set of logical fields 208 and model entities 225. Users compose an abstract query 202 by specifying logical fields 208 to include in selection criteria 203 and results criteria 204. An abstract query 202 may also identify a model entity 201 from the set of model entities 225. The resulting query is generally referred to herein as an “abstract query” because it is composed using logical fields 208 rather than direct references to data structures in the underlying physical databases 214. The model entity 225 may be used to indicate a logical focus of the abstract query 202 (e.g., a query focused on a “patient”, a “person”, an “employee”, a “test”, a “facility” etc). The data abstraction model 148 may include a model entity defining the model entity relative to data in the underlying physical database. For example, instances of the “patient” model entity may be defined relative to a “patient ID” value stored in a “demographics” of the underlying physical database. Of course, the exact definition for any model entity may be tailored according to the circumstances of a particular case.

Illustratively, abstract query 202 includes an indication that query 202 is directed to instances of a “patient” model entity 201, and further includes selection criteria 203 indicating that patients with a “hemoglobin_test>20” should be retrieved. The selection criteria 203 are composed by specifying a condition evaluated against the data values corresponding to a logical field 208 (in this case the “hemoglobin_test” logical field. The operators in a condition typically include comparison operators such as =, >, <, >=, or, <=, and logical operators such as AND, OR, and NOT. Results criteria 204 indicates that data retrieved for this abstract query 202 includes data for the “name,” “age,” and “hemoglobin_test” logical fields 208.

As stated, in one embodiment, an abstract query may specify a type of model entity being queried (e.g., a patient, an employee or a test). The model entity defines a logical focus, or central concept, for an abstract query. Thus, rather than compose a query data based on the structure of an underlying database (e.g., an SQL schema), users compose a query about a model entity (e.g., about a patient) by specifying which logical fields should be used to evaluate whether a given instance of the model entity (i.e., data related to a particular patient) should be included in the query results. Doing so allows users to compose complex queries in a straightforward and intuitive manner. Numerous examples of model entities used to provide a focus for an abstract query are described in commonly assigned U.S. Pat. No. 7,054,877 (the '877 patent) entitled “Dealing with Composite Data through Data Model Entities.”

In one embodiment, runtime component 114 (also referred to as a query builder) may be configured to retrieve data from physical database 214 by generating a resolved query (e.g., an SQL statement) from abstract query 202. Because database abstraction model 148 is tied to neither the schema of physical database 214 nor the syntax of a particular query language, additional capabilities may be provided by database abstraction model 148 without having to modify the underlying database. Further, depending on the access method specified for a logical field, runtime component 114 may transform abstract query 202 into an XML query that queries data from database 214₁, an SQL query of relational database 214₂, or other query composed according to another physical storage mechanism using other data representation 214₃, or combinations thereof (whether currently known or later developed).

FIG. 2B illustrates an exemplary abstract query 202, relative to the database abstraction model 148, according to one embodiment of the invention. As shown in FIG. 2B, abstract query 202 includes selection criteria 203 indicating that the query should retrieve instances of the patient model entity 201 with a “hemoglobin_test” test value greater than “20.” The particular information retrieved using abstract query 202 is specified by result criteria 204. In this example, the abstract query 202 retrieves a patient's name and a test result value for a hemoglobin test. The actual data retrieved may include data from multiple tests. That is, the query results may exhibit a one-to-many relationship between a particular model entity and the query results.

An illustrative abstract query corresponding to abstract query 202 is shown in Table I below. In this example, the abstract query 202 is represented using extensible markup language (XML). In one embodiment, query interface 115 may be configured to enable a user to compose an abstract query, and to generate an XML document to represent the finished abstract query. Those skilled in the art will recognize that XML is a well known markup language used to facilitate the sharing of structured text and information. Of course, other markup languages may be used.

TABLE I
Query Example

001 <?xml version=“1.0”?>
002 <!--Query string representation: (“Hemoglobin_test > 20”)
003 <QueryAbstraction>
004 <Selection>
005 <Condition>
006 <Condition field=“Hemoglobin Test” operator=“GT”
value=“20”
007 </Condition>
008 </Selection>
009 <Results>
010 <Field name=“FirstName”/>
011 <Field name=“LastName”/>
012 <Field name=“Hemoglobin Test”/>
013 </Results>
014 <Entity name=“Patient” >
015 <FieldRef name=“data://patient/PID” />
016 <Usage type=“query” />
017 </EntityField>
018 </Entity>
019 </QueryAbstraction>

The XML markup shown in Table I includes the selection criteria 203 (lines 004-008) and the results criteria 204 (lines 009-013). Selection criteria 203 includes a field name (for a logical field), a comparison operator (=, >, <, etc) and a value expression (what the field is being compared to). In one embodiment, the results criteria 204 include a set of logical fields for which data should be returned. The actual data returned is consistent with the selection criteria 203. Lines 14-18 identify the model entity selected by a user, in this example, a “Patient” model entity. Thus, the query results returned for abstract query 202 are instances of the “Patient” model entity and data for the results criteria specified in the query (lines 009-013). Line 15 indicates the identifier in the physical database 214 used to identify instances of the model entity. In this case, instances of the “Patient” model entity are identified using values from the “Patient ID” column of a patient table.

After composing an abstract query, a user may submit it to runtime component 114 for processing. In one embodiment, runtime component 114 may be configured to process abstract query 202 by generating an intermediate representation of abstract query 202, such as an abstract query plan. In one embodiment, an abstract query plan is composed from a combination of abstract elements from the data abstraction model and physical elements relating to the underlying physical database. For example, an abstract query plan may identify which relational tables and columns are referenced by which logical fields included in abstract query 202, and further identify how to join columns of data together. Runtime component 114 may then parse the intermediate representation in order to generate a physical query of the underlying physical database (e.g., an SQL statement(s)).

FIG. 2B further illustrates an embodiment of a database abstraction model 148 that includes a plurality of logical field specifications 208₁₋₅ (five shown by way of example). The access methods included in logical field specifications 208 (or logical field, for short) are used to map the logical fields 208 to tables and columns in an underlying relational database (e.g., database 214₂ shown in FIG. 2A). As illustrated, each field specification 208 identifies a logical field name 210₁₋₅ and an associated access method 212₁₋₅. Depending upon the different types of logical fields, any number of access methods may be supported by database abstraction model 148. FIG. 2B illustrates access methods for simple fields, filtered fields, and composed fields. Each of these three access methods are described below.

A simple access method specifies a direct mapping to a particular entity in the underlying physical database. Field specifications 208₁, 208₂, and 208₅ each provide a simple access method, 212₁, 212₂, and 212₅, respectively. For a relational database, the simple access method maps a logical field to a specific database table and column. For example, the simple field access method 212₁ shown in FIG. 2B maps the logical field name 210₁ “FirstName” to a column named “f_name” in a table named “Demographics.”

Logical field specification 208₃ exemplifies a filtered field access method 212₃. Filtered access methods identify an associated physical database and provide rules defining a particular subset of items within the underlying database that should be returned for the filtered field. Consider, for example, a relational table storing test results for a plurality of different medical tests. Logical fields corresponding to each different test may be defined, and a filter for each different test is used to associate a specific test with a logical field. For example, logical field 208₃ illustrates a hypothetical “Hemoglobin Test.” The access method for this filtered field 212₃ maps to the “Test_Result” column of a “Tests” tests table and defines a filter “Test_ID=‘1243’.” Only data that satisfies the filter is returned for this logical field. Accordingly, the filtered field 208₃ returns a subset of data from a larger set, without the user having to know the specifics of how the data is represented in the underlying physical database, or having to specify the selection criteria as part of the query building process.

Field specification 208₄ exemplifies a composed access method 212₄. Composed access methods generate a return value by retrieving data from the underlying physical database and performing operations on the data. In this way, information that does not directly exist in the underlying data representation may be computed and provided to a requesting entity. For example, logical field access method 212₄ illustrates a composed access method that maps the logical field “age” 208₄ to another logical field 208₅ named “birthdate.” In turn, the logical field “birthdate” 208₅ maps to a column in a demographics table of relational database 214₂. In this example, data for the “age” logical field 208₄ is computed by retrieving data from the underlying database using the “birthdate” logical field 208₅, and subtracting a current date value from the birth date value to calculate an age value returned for the logical field 208₄. Another example includes a “name” logical filed (not shown) composed from the first name and last name logical fields 208₁ and 208₂.

By way of example, the field specifications 208 shown in FIG. 2B are representative of logical fields mapped to data represented in the relational data representation 214₂. However, other instances of database abstraction model 148 or, other logical field specifications, may map to other physical data representations (e.g., databases 214₁ or 214₃ illustrated in FIG. 2A). Further, in one embodiment, database abstraction model 148 is stored on computer system 110 using an XML document that describes the model entities, logical fields, access methods, and additional metadata that, collectively, define the database abstraction model for a particular physical database system. Other storage mechanisms or markup languages, however, are also contemplated.

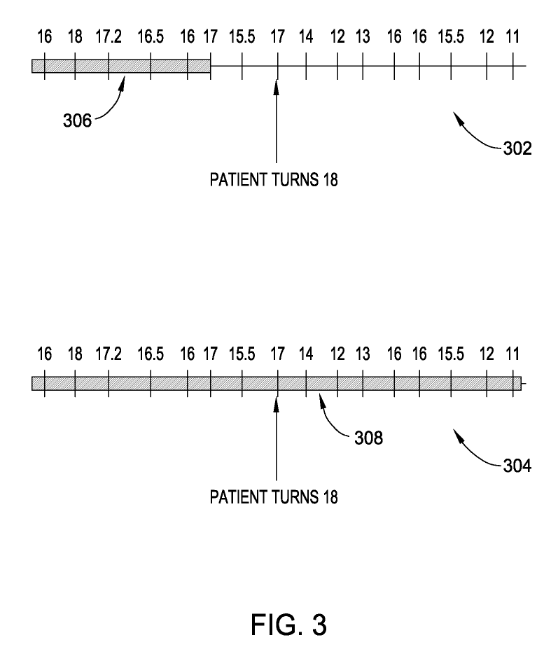

FIGS. 3-5 provide examples of different scenarios where logical fields are used to create record set constraints for entity based conditions, as well as value constraints, and record based constraints. First, FIG. 3 illustrates an example of using an “AgeAtTest” logical field to create a record set constraint versus a value constraint for an entity based condition, according to one embodiment of the invention. Graphs 302 and 304 each show an example set of hemoglobin measurements for a patient over a period of time (values on the left are oldest, values on the right are newest). If a researcher wants a query to return data related to patients who always had an above normal hemoglobin values (e.g., greater than 15) while they were children (e.g., less than 18 years old), then the value constraint, “hemoglobin_test>15,” is applied as an entity based condition. The condition, “AgeAtTest<18,” is applied as a record set constraint (used to constrain the entity based condition), which causes the entity based condition to only be applied to test values within a shaded area 306 of graph 302. Illustratively, the patient matches the entity based condition because all of the hemoglobin values are greater than 15, where the patient's age is under 18. However, if “AgeAtTest<18” is applied as an additional value constraint instead of a record set constraint, then the resulting entity based condition (“hemoglobin_test>15” and “AgeAtTest<18”) is applied to all of the patient's records 308, as shown in the graph 304. Here, the patient does not match the entity based condition because there are records where hemoglobin is less than 15, and there are also records where AgeAtTest is 18 or greater.

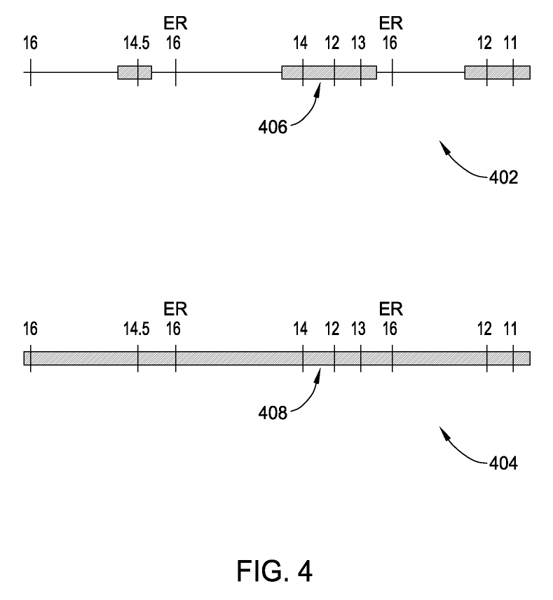

FIG. 4 illustrates an example of using a “TestLocation” logical field to create a record set constraint versus a value constraint for an entity based condition, according to one embodiment of the invention. Both graphs 402 and 404 show an example set of hemoglobin measurements for a patient taken over a period of time. Assume a researcher wants a query to return all hemoglobin values for patients who always had a below normal hemoglobin value (e.g., less than 15) when the test was not administered in an emergency room. In such a case, the value constraint, “hemoglobin_test<15,” is applied as an entity based condition, and the condition, “TestLocation<>EmergencyRoom,” is applied as a record set constraint. Again, the record set constraint constrains the entity based condition to only be applied to the shaded area 406 (i.e., to measurements not taken in an emergency room). Here, the patient matches the entity based condition because all of the hemoglobin values are less than 15 in the shaded areas. Thus, data related to this patient would appear in query output. However, if “TestLocation<>EmergencyRoom” is applied as an additional value constraint instead of a record set constraint, then the resulting entity based condition (“hemoglobin_test<15” and “TestLocation<>EmergencyRoom”) is applied to all of the patient's records 408, as shown in the second graph 404. Here, the patient does not match the entity based condition because there are records where hemoglobin is less than 15, and there are also records where the test location is an emergency room.

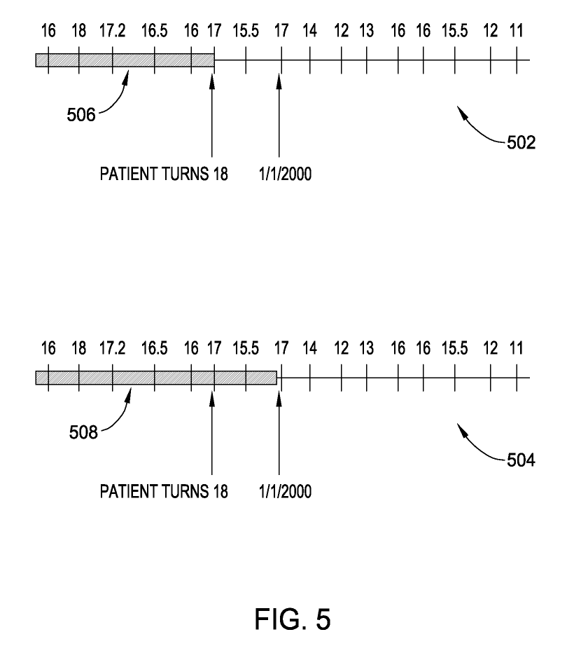

FIG. 5 illustrates an example of specifying a date as a record set constraint for an entity based condition, while using the “AgeAtTest” logical field to create a an additional record set constraint versus a value constraint, according to one embodiment of the invention. Both graphs 502 and 504 show an example set of hemoglobin measurements taken for a patient over a period of time. In this example, assume the condition of “Date<Jan. 1, 2000” is applied as a first record set constraint. If a researcher wants to compose a query to return all hemoglobin values for patients who always had an above normal hemoglobin value while under 18 years old, then the value constraint, “hemoglobin_test>15,” is applied as an entity based condition. The condition, “AgeAtTest<18,” is applied as a second record set constraint, which causes the entity based condition to only be applied to the shaded area 506. Illustratively, the patient matches the entity based condition (“hemoglobin₁₃ test>15”) because all of the hemoglobin values are greater than 15 in the shaded areas. That is, the hemoglobin values are greater than 15 for all measurements, as constrained by the first record set constraint “Date<Jan. 1, 2000” and the record set constraint “AgeAtTest<18”. Alternatively, however, if “AgeAtTest<18” is applied as an additional value constraint, instead of a second record set constraint, then the resulting entity based condition (“hemoglobin_test<15” and “AgeAtTest<18”) is applied to more of the patient's records 508 as constrained by only the first record set constraint “Date<Jan. 1, 2000”, as shown in the second graph 504. In such a case, the patient does not match the entity based condition because there are records where hemoglobin is less than 15, and there are also records where the patient is 18 or older within the constrained set of records having “Date<Jan. 1, 2000”.

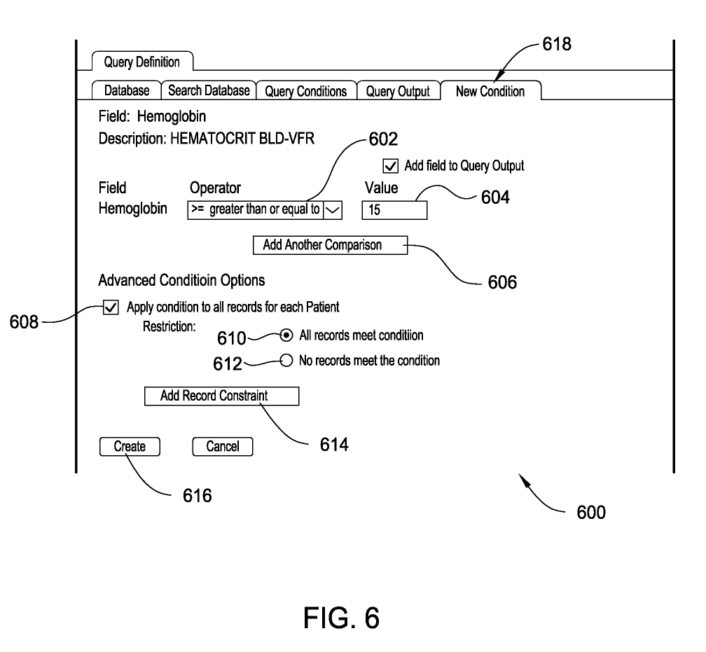

FIG. 6 illustrates an example query interface 600 used to build a query that applies value constraints and/or record set constraints to entity based conditions, according to one embodiment of the invention. Query interface 600 provides an intuitive and simple interface used for building entity based conditions, and for specifying value or record set constraints for an entity based condition. As shown, a “New Condition” tab 618 is selected and query interface 600 displays interface elements used to specify values and characteristics of the entity based condition. Specifically, in this example, a value constraint is being specified as an entity based condition for the hemoglobin field. Illustratively, an operator 602 is set to “greater than or equal” and a value 604 of “15” is specified for the value based constraint being composed. A button 606 allows the user to specify additional value constraints. In one embodiment, a user may select a checkbox 608 to specify that the condition being composed should be applied as an entity based condition. That is, all (or no) data related to a given entity should satisfy the entity based condition to be included in query output. Then, the user specifies whether all records or no records must meet the condition (i.e., always or never), using radio buttons 610 and 612. In one embodiment, the user may also specify a record set constraint—a constraint used to constrain records evaluated for the entity based condition using interface 600. For example, a button 614 may allow the user to specify a record set constraint. Once the user completes composing a condition, the may select the “Create” button 616 to add the completed condition to the abstract query.

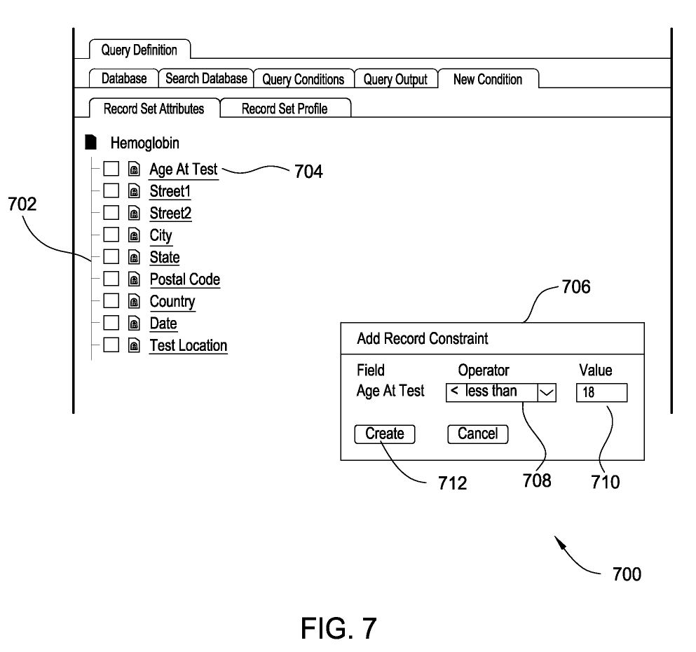

FIG. 7 illustrates an example interface 700 used to a record set constraint to an entity based condition, according to one embodiment of the invention. When the user selects the “Add Record Constraint” button 614 of interface 600 of FIG. 6, the interface 700 may display a list of logical fields 702 used to define a record set constraint. In this example, assume the “AgeAtTest” logical field 704 is selected. In response, interface 700 may be configured to display a pop-up box 706. A drop-down box 708 allows the user to select an operator for the record set constraining condition. Illustratively, the “less than” operator 708 is selected, and the user has entered “18” in the value box 710. Once the operator and value are specified, the user selects the “Create” button 712. In this example, the “AgeAtTest<18” condition is applied as a record set constraint to the entity based condition of “Hemoglobin_test>=15.” That is, the user is requesting to identify patients with hemoglobin tests always above 15 (i.e., the entity based condition), but only for test measurements obtained while a patient was less than 18 (the record set constraint).

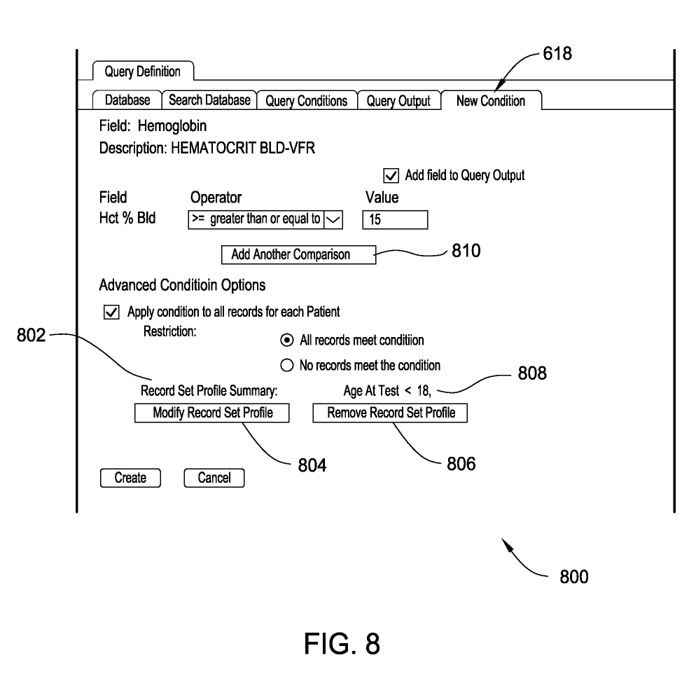

FIG. 8 illustrates an example query interface 800 used to build an entity based condition that includes a record set constraint, according to one embodiment of the invention. Query interface 800 shows an updated version of query interface 600 after a user has completed entering the “AgeAtTest<18” record set constraint. Illustratively, interface 800 includes a record set profile summary 802 that displays record set constraints 808. In one embodiment, query interface 800 may edit or remove record set constraints from an entity based condition. For example, a user may interact with query interface 800 to modify a record set profile (i.e., a collection of one or more record set constraints) using button 804 or remove a record set profile using button 806 to remove a constraint using button 806. Additionally, interface 800 may allow a user to add additional record set constraints to an entity based condition using button 810. In such a case, the user may select a logical field to create a new constraint with as described above in conjunction with the interface 700 of FIG. 7. Of course, one of ordinary skill in the art will recognize that the graphical interfaces shown in FIGS. 6-8 provide an example of an interface for creating record set constraints for entity based conditions.

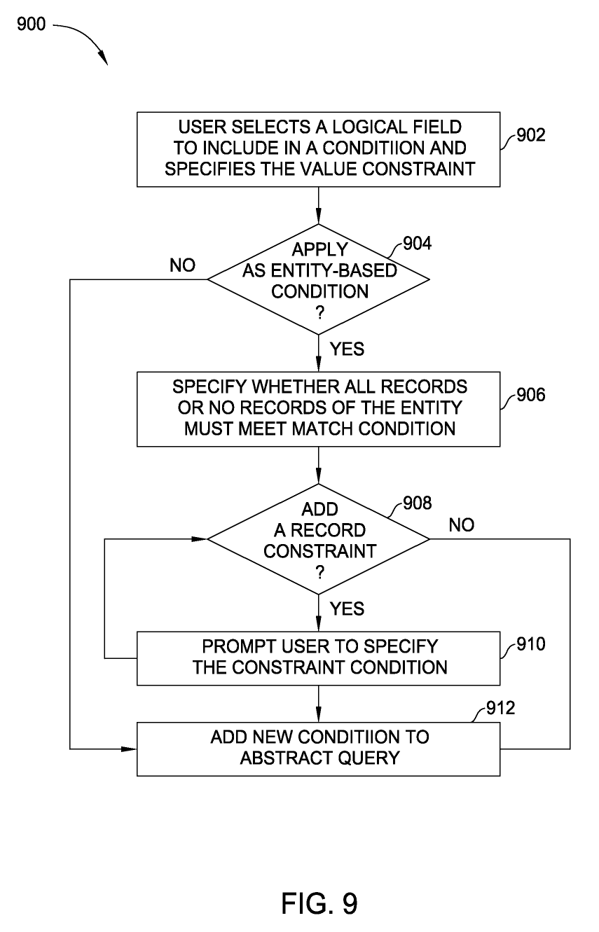

FIG. 9 is a flow diagram illustrating a method 900 for displaying and receiving value constraints and record set constraints for an entity based condition, according to one embodiment of the invention. As described, a user may compose an abstract query by selecting logical fields and specifying conditions. As shown, the method 900 begins at step 902 where a user specifies a value constraint for a logical field (step 902). For example, the user may interact with the query interface 600 of FIG. 6 to specify a value constraint such as “hemoglobin_test>15.” If the user does not choose to apply the value constraint as an entity based condition at step 904, then the new condition is added to the abstract query at step 912. If the user does apply the value constraint as an entity based condition, then the user may specify whether all (or none) of the patient's records should satisfy the entity based condition in order for data related to a given patient to be included in query output (step 906). At step 908, if the user does not select a record set constraint, then the new condition is added to the abstract query. Otherwise, the user may interact with interface (e.g., interface 700 of FIG. 7) to specify a constraining condition for the record set constraint (step 910). At step 908, additional record constraints may be added. If no more constraints are added, then the new record set constraint may be added to the abstract query being composed (step 912).

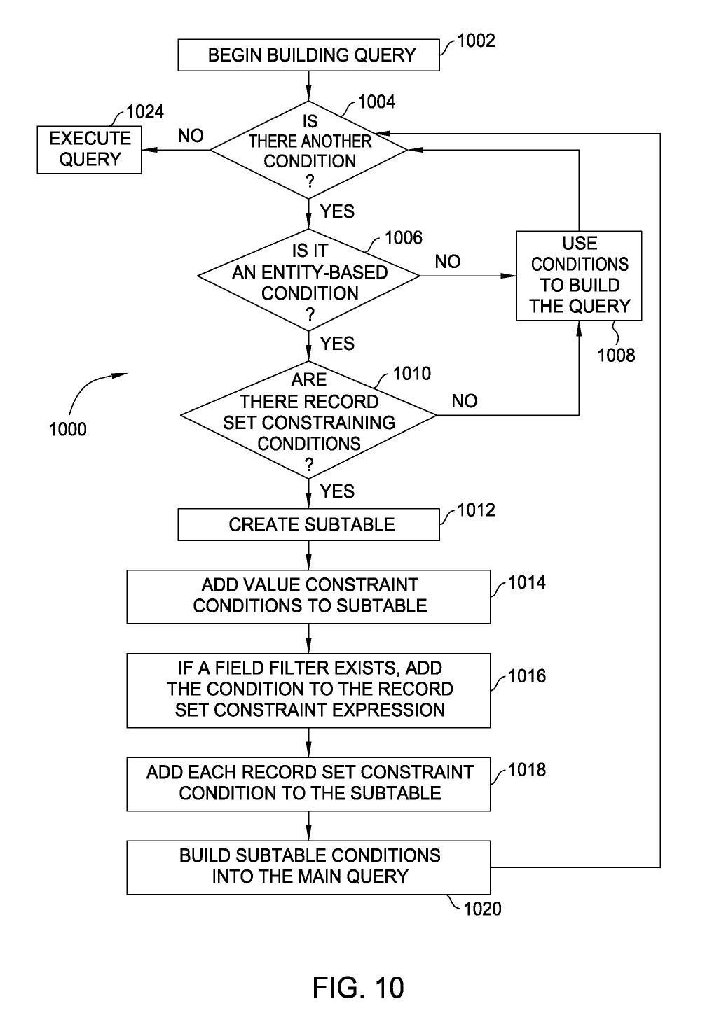

FIG. 10 is a flow diagram illustrating a method 1000 for building a resolved query for an abstract query that includes an entity based condition with a record set constraint, according to one embodiment of the invention. Once all of the conditions have been added to the abstract query, the query builder (e.g, runtime component 114 of FIG. 2A), may generate a resolved query from the abstract query. At step 1004, the query builder may determine whether another query condition exists. If so, then the query builder may determine whether a condition then currently being evaluated is an entity based condition (step 1006). Otherwise, then the query builder generates the appropriate query contribution representing the condition (e.g., a fragment of SQL) for the resolved query (step 1008). If the condition being processed is an entity based condition, then the query builder may determine whether the user specified any record set constraining conditions for the entity based condition. If not, then the query builder generates the appropriate query contribution representing the entity based condition (e.g., a fragment of SQL) into the query at step 1008. If the condition being evaluated includes one or more record set constraining conditions, then the query builder may generate a query contribution (e.g., a fragment of SQL) to generate a sub-table (step 1014). In one embodiment, the sub-table is used to create a sub query that determines whether a given patient satisfies the value constraints specified for the entity based condition, for the rows specified in the record set constraint. At step 1016, the value constraints are added to the sub-table. At step 1018, if a field filter exists, then the condition is added to the record set constraint expression. For example, the filter “Test_ID=1243,” from the Hemoglobin test logical field of FIG. 2B, may be used to limit the test values evaluated to only hemoglobin tests. At step 1020, additional record set constraints may be added to the sub-table. At step 1022, the sub-table query conditions are built into the main query. At step 1004, if there are no more conditions, the query is then executed (step 1024).

Table I, below, illustrates an SQL query composed according to method 1000, using the example of FIG. 5. In this example, the query is generated in response to an abstract query of the “patient” model entity that includes an entity based condition and record set constraint. Specifically, an entity based condition with a value constraint of “hemoglobin_test>15.” Further, the entity based condition includes two record set constraint (applied to the “hemoglobin_test>15 value constraint). Specifically, the constraints of: “AgeAtTest<18” and “date<Jan. 1, 2000.”

TABLE II
EXAMPLE SQL QUERY

```
001 SELECT
002  “t1”.“PATIENT_ID” AS “Patient ID”,
003  “t2”.“Hemoglobin” AS “ Hemoglobin ”
004 FROM
005  “DQBSAMPL”.“PATIENTINFO” “t1”
006  LEFT JOIN (
007  SELECT DISTINCT
008  “t5”.“PATIENT_ID”
009  FROM
010  “DQBSAMPL”.“PATIENTINFO” “t8”
011  LEFT JOIN “DQBSAMPL”.“TESTRESULTS” “t5” ON
012  “t8”.“PATIENT_ID” = “t5”.“PATIENT_ID”
013  WHERE
014  ( ( NOT( CAST(“t5”.”NUMERIC_VALUE” AS
          DECIMAL(15,3))
015  >= 15)
016  AND ( CAST(“t5”.”TEST_DTTM” AS DATE) <
          ‘Jan-1-2000’
017  AND EXTRACT (YEAR FROM “t5”.”TEST_DTTM”) −
018  EXTRACT(YEAR FROM “t8”.”BIRTH_DTTM”) < 18) )
019  AND “t5”.“LOINC_CODE” = ‘20570-8’)
020  ) “t6” ON “t1”.“PATIENT_ID” = “T6”.“PATIENT_ID”
021  LEFT JOIN (
022  SELECT
023  CAST (“t7”.“NUMERIC_VALUE” AS
          DECIMAL(15, 3)) AS
024  “Hemoglobin”, “t7”.“PATIENT_ID” FROM
025  “DQBSAMPL”.“TESTRESULTS”
026  “t7”
027  WHERE
028  “t7”.“LOINC_CODE” = ‘20570-8’
029  ) “t2” ON “t1”.“PATIENT_ID” = “t2”.“PATIENT_ID”
030  WHERE
031  ( “t6”.“PATIENT_ID” IS NOT NULL)
```

As shown, the query on lines 001-005 and 030-031 selects hemoglobin values for patients that satisfy the entity based condition (“hemoglobin_test>15”) with the record set constraints on the entity based condition of “AgeAtTest<18” and ∂date<Jan. 1, 2000.”

Lines 014-015 of Table II show the value constraining condition, which is built using the database column that contains the numeric value of the hemoglobin test (step 1008 of method 1000). Lines 16-18 show the record set constraining conditions (step 1020 of method 1000), built using the corresponding database columns. Specifically, line 016 constrains the record set to values that were recorded before Jan. 1, 2000. Lines 017-018 constrains the record set to values that were recorded while the patient was less than 18 years old (step 1020 of method 1000). Of course, many other types of constraining conditions may be used to constrain the record set. Line 019 illustrates the query language generated at step 1018 of method 1000, where condition for the field filter is added. In this case, assume the condition of “LOINC_CODE”=‘20570-8” is used to specify a hemoglobin test. Lines 030-031 are used to test which patients did or did not match the entity based condition specified by the abstract query.

Advantageously, embodiments provide a convenient way for users to apply value constraints and record set constraints to entity based conditions, and to build a query from those conditions, without the need for spending time to write complicated queries, like the query of Table II. In one embodiment, a query builder uses the conditions to generate sub-tables and query code for execution. The sub-tables are used to create query language statements (e.g., SQL statements) that limit the record set against which entity based conditions are evaluated. Thus, the present invention provides an efficient method to create record constraints for entity based conditions, while reducing the amount of time and errors associated with manually composing query code.

While the foregoing is directed to embodiments of the present invention, other and further embodiments of the invention may be devised without departing from the basic scope thereof, and the scope thereof is determined by the claims that follow.

What is claimed is:

1. A method of processing an abstract query composed from a plurality of logical fields specified by a data abstraction model constructed for an underlying physical database, comprising:
receiving an abstract query composed from one or more of the plurality of logical fields, wherein the abstract query includes a selection of a model entity, wherein the model entity specifies a logical focus for the abstract query and wherein the abstract query further includes:
(i) an entity based condition specifying a condition which must be satisfied for each value included in a collection of values related to a given instance of the model entity in order for the given instance of the model entity to be included in query output; and
(ii) a record set constraint specifying a condition to constrain the collection of records against which the entity based condition is evaluated;
generating a resolved query of the underlying physical database;
executing the resolved query to retrieve a set of query output that includes a set of instances of the model entity that satisfy the entity based condition; and
returning the query output to a user.

2. The method of claim 1, wherein generating the resolved query comprises generating a structured query language (SQL) statement configured to evaluate each instance of the model entity based on the entity based condition and the record set constraint.

3. The method of claim 2, wherein the SQL statement generates at least one sub-table, wherein the sub-table is used to store the collection of data values, as constrained by the record set constraint.

4. The method of claim 1, wherein each logical field is associated with a logical field definition in the data abstraction model, wherein the definition provides at least an access method specifying a method for accessing data from the underlying physical database.

5. The method of claim 1, wherein the entity based condition includes two or more record set constraints.

6. The method of claim 1, wherein the resolved query includes query conditions generated for conditions in the abstract query other than the entity based condition.

7. The method of claim 1, wherein the user interacts with a graphical user interface specify entity based condition and record set constraint.

8. A computer-readable storage medium containing a program which, when executed, performs an operation for processing an abstract query composed from a plurality of logical fields specified by a data abstraction model constructed for an underlying physical database, the operation comprising:
receiving an abstract query composed from one or more of the plurality of logical fields, wherein the abstract query includes a selection of a model entity, wherein the model entity specifies a logical focus for the abstract query and wherein the abstract query further includes:
(i) an entity based condition specifying a condition which must be satisfied for each value included in a collection of values related to a given instance of the model entity in order for the given instance of the model entity to be included in query output; and
(ii) a record set constraint specifying a condition to constrain the collection of records against which the entity based condition is evaluated;
generating a resolved query of the underlying physical database;
executing the resolved query to retrieve a set of query output that includes a set of instances of the model entity that satisfy the entity based condition; and
returning the query output to a user.

9. The computer-readable storage medium of claim 8, wherein generating the resolved query comprises generating a structured query language (SQL) statement configured to evaluate each instance of the model entity based on the entity based condition and the record set constraint.

10. The computer-readable storage medium of claim 9, wherein the SQL statement generates at least one sub-table, wherein the sub-table is used to store the collection of data values, as constrained by the record set constraint.

11. The computer-readable storage medium of claim 8, wherein each logical field is associated with a logical field definition in the data abstraction model, wherein the definition provides at least an access method specifying a method for accessing data from the underlying physical database.

12. The computer-readable storage medium of claim 8, wherein the entity based condition includes two or more record set constraints.

13. The computer-readable storage medium of claim 8, wherein the resolved query includes query conditions generated for conditions in the abstract query other than the entity based condition.

14. The computer-readable storage medium of claim 8, wherein the user interacts with a graphical user interface specify entity based condition and record set constraint.

15. A system, comprising:
a processor; and
a memory containing a program configured to perform an operation for processing an abstract query composed from a plurality of logical fields specified by a data abstraction model constructed for an underlying physical database, the operation comprising:
receiving an abstract query composed from one or more of the plurality of logical fields, wherein the abstract query includes a selection of a model entity, wherein the model entity specifies a logical focus for the abstract query and wherein the abstract query further includes:
(i) an entity based condition specifying a condition which must be satisfied for each value included in a collection of values related to a given instance of the model entity in order for the given instance of the model entity to be included in query output; and
(ii) a record set constraint specifying a condition to constrain the collection of records against which the entity based condition is evaluated;
generating a resolved query of the underlying physical database;
executing the resolved query to retrieve a set of query output that includes a set of instances of the model entity that satisfy the entity based condition; and
returning the query output to a user.

16. The system of claim 15, wherein generating the resolved query comprises generating a structured query language (SQL) statement configured to evaluate each instance of the model entity based on the entity based condition and the record set constraint.

17. The system of claim 16, wherein the SQL statement generates at least one sub-table, wherein the sub-table is used to store the collection of data values, as constrained by the record set constraint.

18. The system of claim 15, wherein each logical field is associated with a logical field definition in the data abstraction model, wherein the definition provides at least an access method specifying a method for accessing data from the underlying physical database.

19. The system of claim 15, wherein the entity based condition includes two or more record set constraints.

20. The system of claim 15, wherein the resolved query includes query conditions generated for conditions in the abstract query other than the entity based condition.

21. The system of claim 15, wherein the user interacts with a graphical user interface specify entity based condition and record set constraint.
